(19) United States
(12) Patent Application Publication
(10) Pub. No.: US 2007/0279574 A1
(43) Pub. Date: Dec. 6, 2007

(54) LIQUID CRYSTAL DISPLAY DEVICE AND DRIVING METHOD THEREOF

(75) Inventors: Hironori Minamizaki, Kanagawa-ken (JP); Hisashi Sasaki, Kanagawa-ken (JP); Haruhiko Okumura, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/754,704

(22) Filed: May 29, 2007

(30) Foreign Application Priority Data
May 30, 2006 (JP) 2006-150565
Mar. 28, 2007 (JP) 2007-085775

(51) Int. Cl. G02F 1/13

(52) U.S. Cl. 349/192

(57) ABSTRACT

A liquid crystal display device comprising: a memory which receives an image signal, and which stores image data; and a correction data generation circuit that performs overdrive processing when the image data is a moving image, the correction data generation circuit having: a subtracter which performs subtraction processing after receiving previous frame image data outputted from the memory and current frame image data; a multiplier which performs multiplication processing by a predetermined multiplication factor after receiving a result of subtraction by the subtracter; and an adder which performs addition processing after receiving a result of multiplication by the multiplier and the current frame image data or the previous frame image data outputted from the memory.

### CROSS-REFERENCE TO RELATED APPLICATIONS

This application is based upon and claims the benefit of priority from the prior Japanese Patent Applications No. 2006-150565, filed on May 30, 2006 and No. 2007-85775, filed on Mar. 28, 2007, the entire contents of which are incorporated herein by reference.

### BACKGROUND OF THE INVENTION

1. Field of the Invention

The present invention relates to a liquid crystal display device, and more particularly relates to a technique of improving image quality of a moving image.

2. Description of the Related Art

In recent years, larger and higher-definition liquid crystal display devices have been developed and application thereof has been expanding as displays for a personal computer, a mobile terminal, a TV, on-vehicle equipment and the like. Moreover, as the personal computer, TV and the like have become more sophisticated, images displayed by the liquid crystal display device have become wide-ranging from still images to moving images. Thus, the liquid crystal display device is required to have display performance with higher image quality. In the case of a liquid crystal display device, the slow response speed of a liquid crystal material makes it difficult to display moving images, while achieving sufficient display performance. For this reason, an overdrive technique is frequently used in the liquid crystal display device. The overdrive technique improves the moving image display performance of a liquid crystal display panel by improving the response speed of liquid crystal cells. This technique uses a look-up table (LUT) that is a table for setting correction data determined from the image data of a previous frame and the image data of a current frame (see, for example, Japanese Patent Application Laid-Open Publication No. 2004-109796 (Page 8, FIG. 2), and U.S. Patent Application Publication No. 2005/0253785).

However, the overdrive technique using the LUT has a problem that every time a new liquid crystal display panel is designed, it is necessary to perform operations of measuring optimum correction data, and of writing to a memory, such as a ROM, an enormous amount of correction data corresponding to the number of gradations of image data. Moreover, the overdrive technique using the LUT also has a problem that the number of output terminals and power consumption are increased. Due to the increase in the number of terminals and in the power consumption, it is problematic to use the overdrive technique using the LUT, particularly, for a mobile terminal such as a portable telephone that strictly limits the number of terminals, and that strongly demands lower power consumption. Besides the portable telephone, a portable digital audio player, a portable game machine and the like, for example, have similar problems when they are designed to display moving images of concerts and simulation games.

### SUMMARY

According to an aspect of the present invention, there is provided a liquid crystal display device comprising:

a memory which receives an image signal, and which stores image data; and

a correction data generation circuit that performs overdrive processing when the image data is a moving image, the correction data generation circuit having: a subtracter which performs subtraction processing after receiving previous frame image data outputted from the memory and current frame image data; a multiplier which performs multiplication processing by a predetermined multiplication factor after receiving a result of subtraction by the subtracter; and an adder which performs addition processing after receiving a result of multiplication by the multiplier and the current frame image data or the previous frame image data outputted from the memory.

According to another aspect of the present invention, there is provided a liquid crystal display device comprising:

a memory which receives an image signal and stores image data;

a slope coefficient storage which stores a slope coefficient inputted from outside; and

a correction data generation circuit which performs overdrive processing when the image data is a moving image, and which directly outputs the image data as still image data when the image data is a still image, the correction data generation circuit having: a subtracter which performs subtraction processing after receiving current frame image data and previous frame image data stored in the memory; a multiplier which performs multiplication processing by use of the slope coefficient after receiving a result of subtraction by the subtracter; and an adder which performs addition processing after receiving a result of multiplication by the multiplier and the current frame image data or the previous frame image data outputted from the memory.

According to another aspect of the present invention, there is provided a liquid crystal display device comprising:

a frame memory which receives an image signal and stores image data;

a slope coefficient storage which stores a plurality of different slope coefficients inputted from outside; and

a correction data generation circuit which performs overdrive processing when the image data is a moving image and which directly outputs the image data as still image data when the image data is a still image, the correction data generation circuit having: a subtracter which subtracts previous frame image data stored in the frame memory from current frame image data; a determination circuit which determines and selects one of the plurality of different slope coefficients according to a result of the subtraction processing; a multiplier which receives a result of subtraction by the subtracter, and performs multiplication processing by use of the slope coefficient selected by the determination circuit; and an adder which receives a result of multiplication by the multiplier and the previous frame image data stored in the frame memory to perform addition processing.

According to another aspect of the present invention, there is provided a liquid crystal display device comprising:

an edge enhancement circuit which receives an image signal, and which performs edge-enhancement processing for a moving image portion when the image has a moving image region;

a memory which receives edge enhancement image data outputted from the edge enhancement circuit after edge enhancement processing, and which stores the image data; and

a correction data generation circuit which performs overdrive processing when the image data is a moving image, the correction data generation circuit having: a subtracter which performs subtraction processing after receiving the edge enhancement image data and the previous frame image data outputted from the memory; a multiplier which performs multiplication processing by a predetermined multiplication factor after receiving a result of subtraction by the subtracter; and an adder which performs addition processing after receiving a result of multiplication by the multiplier and the previous frame image data outputted from the memory or the edge enhancement image data.

According to another aspect of the present invention, there is provided a method for driving a liquid crystal display device, comprising:

storing image data in a frame memory;

subtracting previous frame moving image data stored in the frame memory from current frame moving image data;

multiplying the moving image data after the subtraction by a first slope coefficient;

obtaining correction moving image data for overdrive by adding the moving image data after the multiplication and the previous frame moving image data stored in the frame memory;

displaying moving image data from the correction moving image data;

determining whether the displayed moving image is an optimum image or an image to be further improved; and

performing subtraction, multiplication and addition processing by use of a second slope coefficient different from the first slope coefficient, when the displayed moving image is determined to be the image to be further improved, and repeating the above processing until the moving image becomes the optimum image.

According to another aspect of the present invention, there is provided a method for driving a liquid crystal display device, comprising:

performing edge-enhancement processing for a moving image portion when image data has a moving image region;

storing the edge-enhanced moving image data in a frame memory;

subtracting previous frame moving image data stored in the frame memory from the edge-enhanced moving image data;

multiplying the moving image data after the subtraction by use of a first slope coefficient;

obtaining correction moving image data for overdrive by adding the multiplied moving image data and the previous frame moving image data stored in the frame memory;

displaying moving image data from the correction moving image data;

determining whether the displayed moving image is an optimum image or an image to be further improved; and

performing subtraction, multiplication and addition processing by use of a second slope coefficient different from the first slope coefficient, when the displayed moving image is determined to be the image to be further improved, and repeating the above processing until the moving image becomes the optimum image.

According to another aspect of the present invention, there is provided a method for driving a liquid crystal display device, comprising:

subjecting, when image data has a moving image region, a moving image portion to edge enhancement processing by use of a first edge enhancement coefficient;

storing the edge-enhanced moving image data in a frame memory;

subtracting previous frame moving image data stored in the frame memory from the edge-enhanced moving image data;

multiplying the moving image data subjected to the subtraction processing by use of a first slope coefficient;

adding the multiplied moving image data and the previous frame moving image data stored in the frame memory to obtain correction moving image data for overdrive;

displaying moving image data from the correction moving image data;

determining whether the displayed moving image is an optimum image or an image to be further improved;

performing subtraction, multiplication and addition processing by use of a second slope coefficient different from the first slope coefficient, when movement of the displayed moving image is determined to be not sharp, and repeating the above processing until the moving image becomes the optimum image; and

repeatedly performing edge enhancement processing on the basis of a second edge enhancement coefficient different from the first edge enhancement coefficient, when it is determined that there is glare on an image edge of the displayed moving image, until the moving image becomes the optimum image.

According to another aspect of the present invention, there is provided a method for driving a liquid crystal display device, comprising:

storing image data in a memory;

switching the image data outputted from the memory between a moving image and a still image;

when the image data is a moving image, subtracting previous frame moving image data stored in the memory from current frame moving image data; multiplying the moving image data subjected to the subtraction processing by use of a slope coefficient; adding the multiplied moving image data and the switched previous frame moving image data to obtain correction moving image data for overdrive; and

displaying images of the correction moving image data having an address designated and of still image data.

According to another aspect of the present invention, there is provided a method for driving a liquid crystal display device, comprising:

an edge enhancement circuit which enhances the edge of a moving image portion, the edge enhancement circuit having: an edge detection circuit which receives an image signal, determines whether an image has a moving image region and a still image region, and, when there is the moving image region, calculates an edge enhancement coefficient according to a movement speed of a moving image; a first subtracter which performs subtraction processing after receiving current frame image data and previous frame image data; a first multiplier which performs multiplication processing on the basis of the edge enhancement coefficient outputted from the edge detection circuit after receiving a result of subtraction by the first subtracter; and a first adder which performs addition processing after receiving a result of multiplication by the first multiplier and the previous frame image data;

a memory which receives edge enhancement image data outputted from the edge enhancement circuit after edge enhancement processing and stores the image data; and

a correction data generation circuit which performs overdrive processing when the image data is a moving image, the correction data generation circuit having: a second subtracter which performs subtraction processing after receiving the edge enhancement image data and the previous frame image data outputted from the memory; a second multiplier which performs multiplication processing by a predetermined multiplication factor after receiving a result of subtraction by the second subtracter; and a second adder which performs addition processing after receiving a result of multiplication by the second multiplier and the previous frame image data outputted from the memory or the edge enhancement image data.

According to another aspect of the present invention, there is provided a liquid crystal display device comprising:

a memory which receives an image signal and stores image data;

a register which stores a slope coefficient inputted from outside;

a switching circuit which receives still image data outputted from the memory and previous frame moving image data, and selectively outputs any one of the received data; and

a correction data generation circuit which, when the image data is a moving image, performs overdrive processing and, when the image data is a still image, directly outputs the image data as still image data, the correction data generation circuit having: a subtracter which subtracts the previous frame moving image data selected by the switching circuit from current frame moving image data; a multiplier which receives a result of subtraction by the subtracter, and performs multiplication processing by use of the slope coefficient; and an adder which receives a result of multiplication by the multiplier and the previous frame moving image data selected by the switching circuit, and performs addition processing.

According to another aspect of the present invention, there is provided a liquid crystal display device comprising:

a frame memory which receives an image signal and stores image data;

a register which stores a slope coefficient inputted from outside;

a first switching circuit which selectively outputs any one of M (M is an integer not less than 2) pieces of previous frame image data outputted from the frame memory;

a correction data generation circuit which, when the image data is a moving image, performs overdrive processing and, when the image data is a still image, directly outputs the image data as still image data, the correction data generation circuit having: a subtracter which subtracts the previous frame image data selected by the first switching circuit from current frame image data; a multiplier which receives a result of subtraction by the subtracter, and performs multiplication processing by use of the slope coefficient; and an adder which receives a result of multiplication by the multiplier and the previous frame image data selected by the first switching circuit, and performs addition processing; and

a second switching circuit which selectively outputs the image data outputted from the correction data generation circuit to any one of m input terminals in an output circuit.

### BRIEF DESCRIPTION OF THE DRAWINGS

FIG. 1 is a schematic block diagram showing a liquid crystal display device according to Embodiment 1 of the present invention.

FIG. 2 is a graph showing a relationship between an interframe differential signal and an overdrive signal according to Embodiment 1 of the present invention.

FIGS. 3A and 3B are views for explaining image levels between frames according to Embodiment 1 of the present invention.

FIG. 4 is a schematic block diagram showing a liquid crystal display device according to Embodiment 2 of the present invention.

FIG. 5 is a flowchart showing operations of the liquid crystal display device according to Embodiment 2 of the present invention.

FIG. 6 is a schematic block diagram showing a liquid crystal display device according to Embodiment 3 of the present invention.

FIGS. 7A and 7B are views for explaining edge enhancement processing according to Embodiment 3 of the present invention.

FIG. 8 is a graph showing a relationship between a movement speed and an edge enhancement coefficient according to Embodiment 3 of the present invention.

FIG. 9 is a flowchart showing operations of the liquid crystal display device according to Embodiment 3 of the present invention.

FIG. 10 is a block diagram showing a source driver for liquid crystal according to Embodiment 4 of the present invention.

FIG. 11 is a block diagram showing a source driver for liquid crystal according to Embodiment 5 of the present invention.

FIG. 12 is a block diagram showing a source driver for liquid crystal according to Embodiment 6 of the present invention.

FIG. 13 is a block diagram showing a source driver for liquid crystal according to Embodiment 7 of the present invention.

FIG. 14 is a view showing regions of a still image and a moving image which are displayed on a display panel according to Embodiment 8 of the present invention.

FIG. 15 is a block diagram showing a source driver for liquid crystal according to Embodiment 8 of the present invention.

FIG. 16 is a flowchart showing operations of a liquid crystal display device according to Embodiment 8 of the present invention.

FIG. 17 is a schematic block diagram showing a liquid crystal display device according to Embodiment 9 of the present invention.

### DETAILED DESCRIPTION

With reference to the drawings, embodiments of the present invention will be described below.

### Embodiment 1

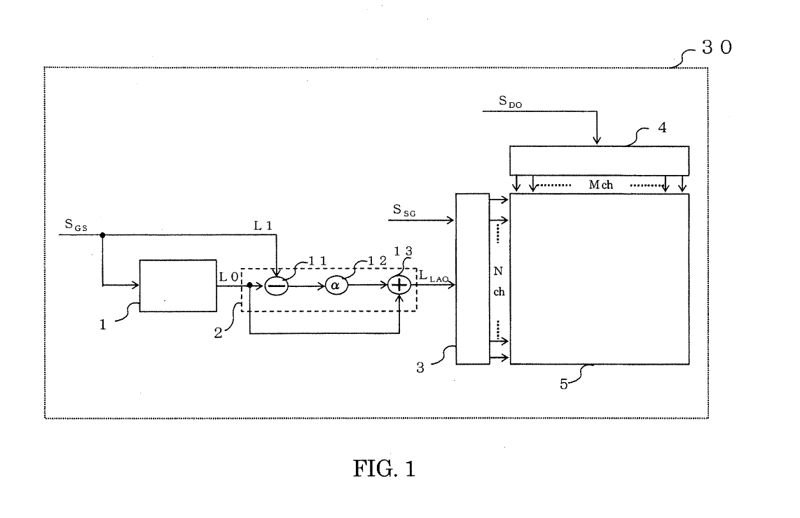

First, a liquid crystal display device according to Embodiment 1 of the present invention will be described with reference to the drawings. FIG. 1 is a schematic block diagram showing a configuration of the liquid crystal display device. In this embodiment, a correction data generation circuit is provided in the liquid crystal display device, for correcting a moving image without using a LUT (Look-up table).

As shown in FIG. 1, a liquid crystal display device 30 includes a frame memory 1, a correction data generation circuit 2, a source driver 3, a gate driver 4 and a display panel (LCD: Liquid Crystal Display) 5. The liquid crystal display device 30 is used in a portable telephone.

The frame memory 1 receives an image signal S_{GS}, stores image information for each frame, and outputs previous frame image data L0 to the correction data generation circuit 2. Here, the image signal S_{GS} is a signal outputted from an unillustrated display controller (a microprocessor may be used), for example. The display controller receives a synchronizing signal such as a clock signal and display data information of red (R), green (G) and blue (B), and then outputs the image signal S_{GS}, a synchronizing signal SDO and a control signal S_{SG} for performing an arithmetic operation to execute the liquid crystal display device 30.

In the correction data generation circuit 2, a subtracter 11, an α multiplier 12 and an adder 13 are provided. The correction data generation circuit 2 is provided between the frame memory 1 and the source driver 3, receives moving image data, and outputs correction image data L_{LAO} for overdrive by arithmetic processing to the source driver 3. Note that, when the image signal S_{GS} is still image data, the correction data generation circuit 2 outputs the still image data directly to the source driver 3.

The subtracter 11 is provided between the frame memory 1 and the α multiplier 12. The subtracter 11 receives current frame image data L1 and the previous frame image data L0 outputted from the frame memory 1, performs subtraction processing, and outputs the result to the α multiplier 12.

The α multiplier 12 is provided between the subtracter 11 and the adder 13. The α multiplier 12 receives a signal outputted from the subtracter 11, performs arithmetic processing by a multiplication factor of α, and outputs the result to the adder 13. Note that α multiplication processing will be described in detail later.

The adder 13 is provided between the frame memory 1 as well as the α multiplier 12 and the source driver 3. The adder 13 receives the previous frame image data LO outputted from the frame memory 1 and the α multiplication result outputted from the α multiplier 12, performs addition processing, and outputs the result as the correction image data L_{LAO} to the source driver 3. Note that the maximum value of the correction image data L_{LAO} is calculated so as not to exceed 2ⁿ−1 gradations when the image data has n bits, for example, so as not to exceed 255 gradations in the case of 8-bit image data.

The source driver 3 is provided between the adder 13 and the display panel 5. The source driver 3 receives the control signal S_{SG} and the correction image data L_{LAO} outputted from the adder 13, and supplies image data that is voltage information to N channels of data lines in the display panel 5. Note that, when the image signal S_{GS} is still image data, the source driver 3 receives the uncorrected still image data and the control signal S_{SG}, and supplies the image data which is voltage information to the N channels of data lines in the display panel 5. Each of the data lines is connected to a source of a TFT (Thin Film Transistor) provided in the display panel 5.

The gate driver 4 receives the synchronizing signal S_{DO} synchronous with the image signal S_{GS} and supplies a voltage for displaying an image to M channels of scanning lines in the display panel 5. Note that each of the scanning lines is connected to a gate of the TFT provided in the display panel 5.

The display panel 5 has the N channels of data lines and the M channels of scanning lines, and displays an image on each of liquid crystal cells on the basis of the data lines and scanning line information.

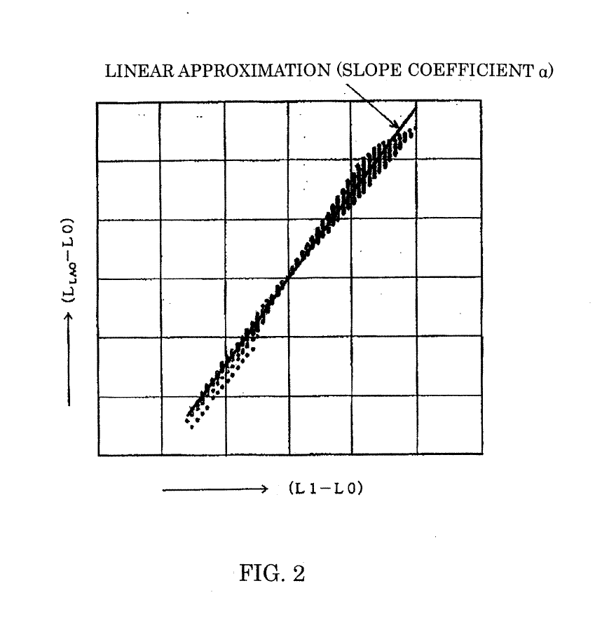

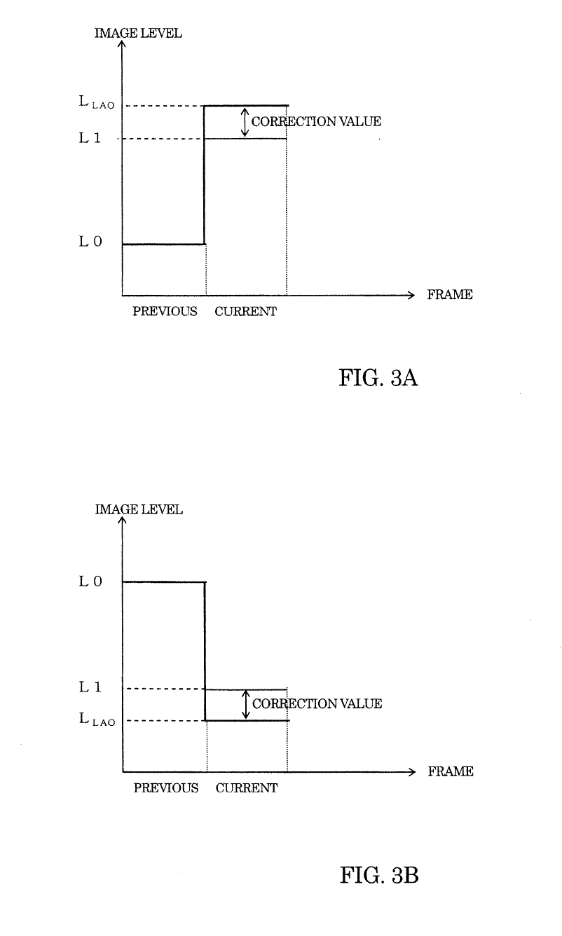

Next, with reference to FIGS. 2 and 3, description will be given of a relationship between an interframe differential signal and an overdrive signal. FIG. 2 is a graph showing a relationship between the interframe differential signal and the overdrive signal. FIGS. 3A and 3B are views for explaining image levels between frames. FIG. 3A is a view for explaining an image level between frames in the case of a change from a lower gradation to a higher gradation. FIG. 3B is a view for explaining an image level between frames in the case of a change from a higher gradation to a lower gradation.

A relationship between the interframe differential signal (L1−L0) and the overdrive signal (L_{LAO}−L0) can be roughly approximated by a straight line, as shown in FIG. 2. Here, when a slope coefficient of the straight line is α, the previous frame image data is L0, the current frame image data is L1 and the correction image data is L_{LAO}, the following equation is established.
L_{LAO}=α(L1−L0)+L0 Equation (1)

Specifically, subtraction processing of (L1−L0) is executed by the subtracter 11, α multiplication processing of α(L1−L0) is executed by the α multiplier 12, and addition processing of α(L1−L0)+L0 is executed by the adder 13, respectively. Thus, correction image data L_{LAO} for overdrive is generated.

Here, in distribution data shown in FIG. 2, a value of the slope coefficient α is 1.4473 and a value r² obtained by squaring a correlation coefficient r is 0.9948, where a strong positive correlation is established between the two values. Note that, when a different liquid crystal material is used for the display panel, the value of the slope coefficient α and the value r² obtained by squaring the correlation coefficient r are different from those described above. However, the strong correlation is maintained. That is, the equation (1) is applicable even when other liquid crystal materials are used for the display panel.

As shown in FIG. 3A, when the image level is changed from a lower gradation to a higher gradation, the correction image data L_{LAO} is obtained by adding a correction value to the current frame image data L1. Here, image intensity of the correction image data L_{LAO} for overdrive is set larger than that of the current frame image data L1. Thus, a moving image display-response speed of the liquid crystal cells can be increased.

Meanwhile, as shown in FIG. 3B, when the image level is changed from a higher gradation to a lower gradation, the correction image data L_{LAO} is obtained by subtracting a correction value from the current frame image data L1. Here, the image intensity of the correction image data L_{LAO} for overdrive is set smaller than that of the current frame image data L1. Thus, a previous frame moving image having large image intensity can be quickly deleted. Note that a slope coefficient α changed as needed is preferably used instead of a fixed slope coefficient α.

As described above, in the liquid crystal display device of this embodiment, the frame memory 1, the correction data generation circuit 2, the source driver 3, the gate driver 4 and the display panel 5 are provided. In the correction data generation circuit 2, the subtracter 11, the α multiplier 12 and the adder 13 are provided. The correction data generation circuit 2 subjects moving image data to overdrive processing, and when the image signal S_{GS} is still image data, outputs the still image data directly to the source driver 3. The subtracter 11 receives the current frame image data L1 and the previous frame image data L0 outputted from the frame memory 1 and performs subtraction processing. The α multiplier 12 receives the signal outputted from the subtracter 11 and performs arithmetic processing by the multiplication factor of α. The adder 13 receives the previous frame image data L0 outputted from the frame memory 1 and the α multiplication result outputted from the α multiplier 12, performs addition processing, and outputs the correction image data L_{LAO} for overdrive to the source driver 3.

Thus, without using the LUT, the moving image can be displayed on the liquid crystal display panel at a high response speed. In addition, it is no longer necessary to perform an operation of writing data to a memory such as a ROM every time a new liquid crystal display panel is designed. To be specific, the necessity is eliminated for writing to the memory an enormous amount of correction data to match the number of gradations of image data by measuring optimum correction data Moreover, since output terminals to correspond with the LUT are no longer required, increase in the number of output terminals can be avoided. Furthermore, since the circuit configuration can be simplified compared with the LUT method, power consumption can be lowered. Therefore, the liquid crystal display device of this embodiment can be applied to that in a portable telephone or the like as a mobile terminal which strictly limits the number of terminals and demands lower power consumption.

### Embodiment 2

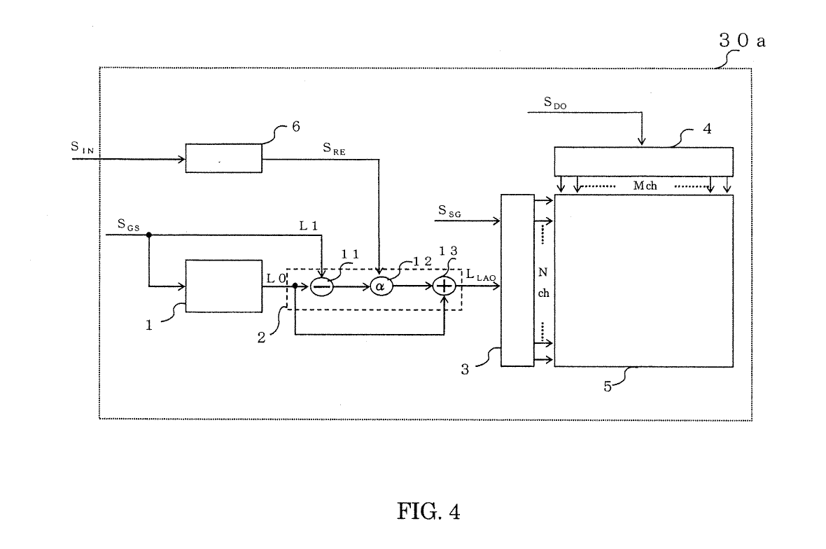

Next, with reference to the drawings, description will be given of a liquid crystal display device and a driving method thereof according to Embodiment 2 of the present invention. FIG. 4 is a schematic block diagram showing the liquid crystal display device. In this embodiment, a register for storing a slope coefficient α is provided.

Hereinafter, the same constituent parts as those in Embodiment 1 will be denoted by the same reference numerals, and description thereof will be omitted. Only different parts will be described below.

As shown in FIG. 4, a liquid crystal display device 30a includes a frame memory 1, a correction data generation circuit 2, a source driver 3, a gate driver 4, a display panel 5 and a register 6. The liquid crystal display device 30a is used in a portable telephone.

The register (slope coefficient storage) 6 receives an input signal S_{IN} including slope coefficient α information inputted from outside the liquid crystal display device 30a, and stores the information. Thereafter, the register 6 outputs a register output signal S_{RE} having the slope coefficient α information to an α multiplier 12. Upon receipt of the slope coefficient α inputted from outside via the register 6, the α multiplier 12 performs α multiplication processing by use of the slope coefficient α. The use of the slope coefficient α inputted from outside enables appropriate setting of optimum moving images for the viewer. Examples of the appropriate setting include: dealing with a change in a liquid crystal property itself due to a surrounding temperature change and a secular change; dealing with correction of a gradation level related to dynamic gamma correction for reducing backlight power consumption; and dealing with a change in a correction amount itself associated with a change in an operation frequency. However, the reasons of the changes should not be limited to those described above. Generally, it is possible to deal with changes due to various reasons.

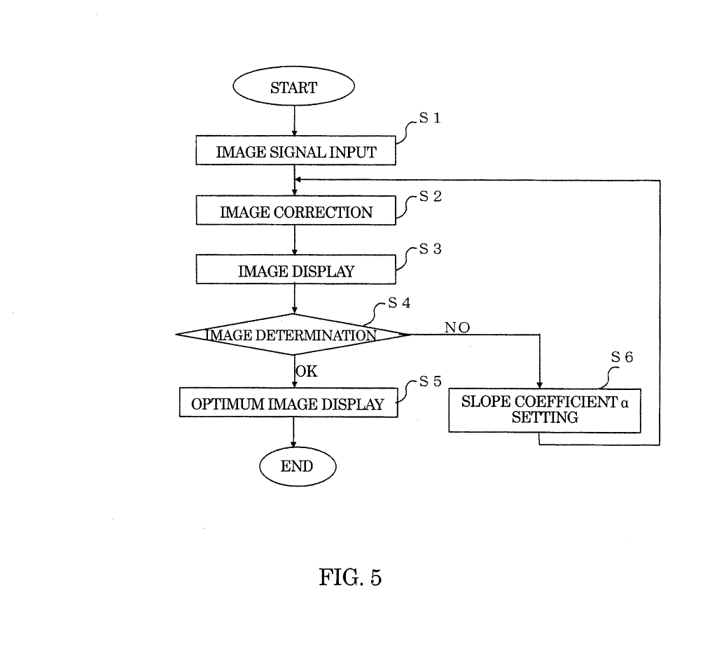

Next, with reference to FIG. 5, operations of the liquid crystal display device will be described. FIG. 5 is a flowchart showing the operations of the liquid crystal display device.

As shown in FIG. 5, first, an image signal S_{GS} is inputted to the frame memory 1, and image data is stored therein (Step S1).

Next, in the case of moving image data, current frame image data and previous frame image data L0 outputted from the frame memory 1 are inputted to a subtracter 11 in the correction data generation circuit 2, and subtraction processing is performed. The image data subjected to the subtraction processing is then subjected to α multiplication processing using a predetermined slope coefficient α1, for example, by the α multiplier 12 in the correction data generation circuit 2. The previous frame image data L0 and the image data subjected to the α multiplication processing are inputted to an adder 13 in the correction data generation circuit 2, and addition processing is performed (Step S2).

Subsequently, correction image data L_{LAO} for overdrive by the addition processing is inputted to the source driver 3. N channels of image data line information outputted from the source driver 3 and scanning line information outputted from the gate driver 4 are inputted to the display panel 5 to display an image thereon (Step S3).

Thereafter, it is determined whether the moving image is an optimum image for the viewer or is an image to be further improved. For example, as a criterion, it is determined whether or not movement of the moving image is sharp (Step S4).

When the moving image is determined to be the optimum image, the image continues to be displayed (Step S5). In contrast, when it is determined that the movement of the moving image is not sharp, for instance, and that the moving image is to be further improved, a slope coefficient α2 different from, and for example, larger than the slope coefficient α1 is inputted from outside via the register 6 to the α multiplier 12 in the correction data generation circuit 2. Subsequently, a multiplication processing is performed on the image data (Step S6). Next, the steps from image correction (Step S2) to image display (Step S3) are carried out on the basis of the image data subjected to the α multiplication processing. The above steps are repeatedly carried out until the moving image is determined to be the optimum image for the viewer.

As described above, in the liquid crystal display device and the driving method thereof according to this embodiment, the frame memory 1, the correction data generation circuit 2, the source driver 3, the gate driver 4, the display panel 5 and the register 6 are provided. In the correction data generation circuit 2, the subtracter 11, the α multiplier 12 and the adder 13 are provided. The correction data generation circuit 2 subjects moving image data to overdrive processing and, when the image signal S_{GS} is still image data, outputs the still image data directly to the source driver 3. The subtracter 11 receives the current frame image data L1 and the previous frame image data L0 outputted from the frame memory 1 and performs subtraction processing. The α multiplier 12 receives the signal outputted from the subtracter 11 and performs arithmetic processing by a multiplication factor of α. The adder 13 receives the previous frame image data L0 outputted from the frame memory 1 and the α multiplication result outputted from the α multiplier 12, performs addition processing, and outputs the correction image data L_{LAO} for overdrive to the source driver 3. The register 6 receives the input signal SIN including the slope coefficient α information inputted from outside the liquid crystal display device 30a, and stores the information. Thereafter, the register 6 outputs the register output signal S_{RE} including the slope coefficient α information to the α multiplier 12. When receiving the slope coefficient α inputted from outside via the register 6, the α multiplier 12 performs a multiplication processing by use of the slope coefficient α.

Thus, without using the LUT, the moving image can be displayed on the liquid crystal display panel at a high response speed. In addition, it is no longer necessary to perform an operation of writing data to a memory such as a ROM every time a new liquid crystal display panel is designed. To be specific, the necessity is eliminated for writing to the memory an enormous amount of correction data to match the number of gradations of image data by measuring optimum correction data Moreover, since output terminals to correspond with the LUT are no longer required, an increase in the number of output terminals can be avoided. Furthermore, since the circuit configuration can be simplified compared with the LUT method, power consumption can be lowered. Also, it is possible to appropriately set the slope coefficient α so as to optimize the movement of the moving image by looking at a liquid crystal display screen from outside. Thus, time required to measure correction data can be shortened, and redesigning is not required for each liquid crystal material or each liquid crystal panel. Therefore, the liquid crystal display device of this embodiment can be applied to that in a portable telephone or the like, as a mobile terminal which strictly limits the number of terminals and demands lower power consumption.

Note that, although moving image determination is made by a person in this embodiment, the determination may be made by use of a measuring instrument. Moreover, instead of the register 6, a memory, for example, a nonvolatile memory may be used to store the slope coefficient α information.

### Embodiment 3

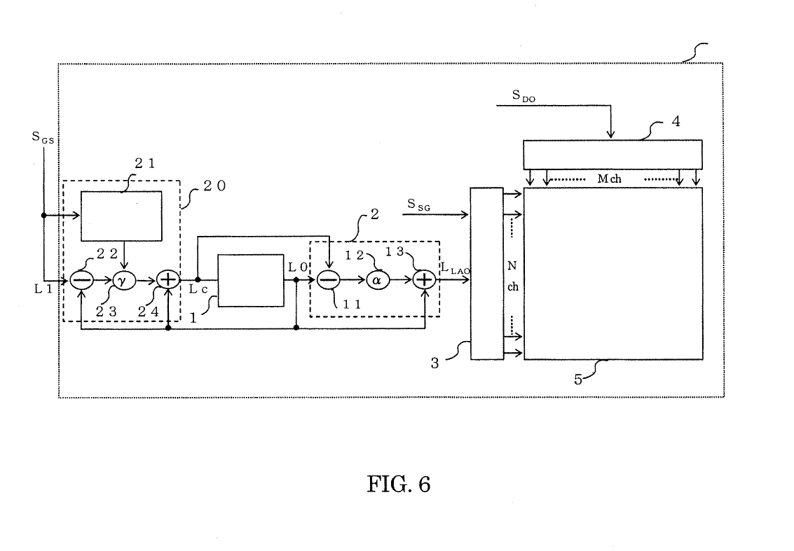

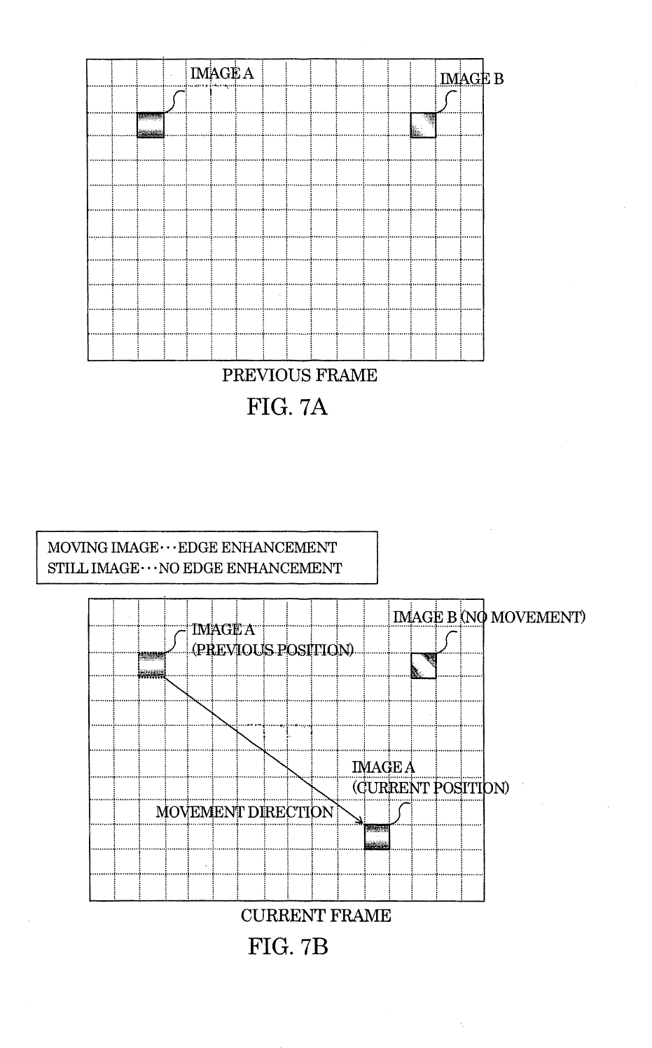

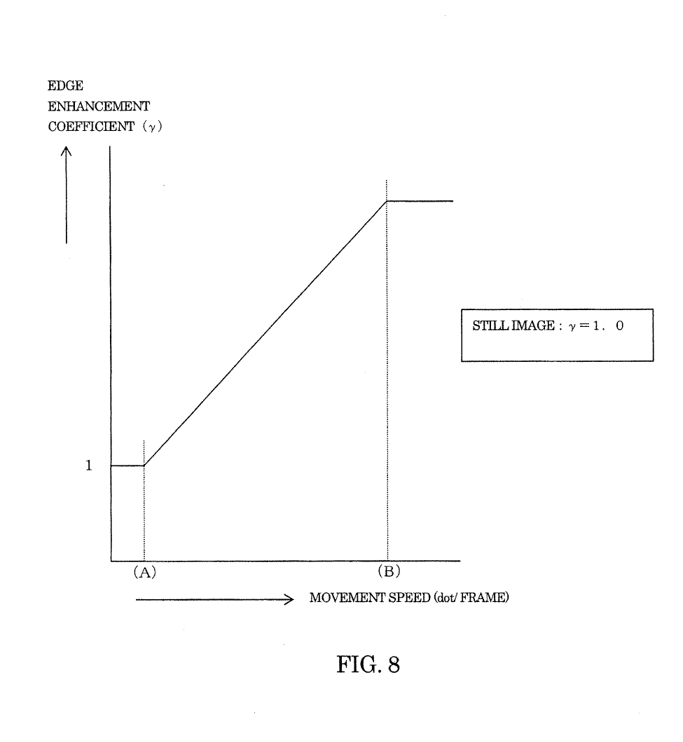

Next, with reference to the drawings, description will be given of a liquid crystal display device according to Embodiment 3 of the present invention. FIG. 6 is a schematic block diagram showing the liquid crystal display device. FIGS. 7A and 7B are views for explaining edge enhancement processing. FIG. 8 is a graph showing a relationship between a movement speed and an edge enhancement coefficient. In this embodiment, in the case of a moving image, overdrive processing is carried out after edge enhancement processing is performed.

Hereinafter, the same constituent parts as those in Embodiment 1 will be denoted by the same reference numerals, and description thereof will be omitted. Only different parts will be described below.

As shown in FIG. 6, a liquid crystal display device 30b includes a frame memory 1, a correction data generation circuit 2, a source driver 3, a gate driver 4, a display panel 5 and an edge enhancement circuit 20. The liquid crystal display device 30b is used in a portable telephone.

In the edge enhancement circuit 20, an edge detection circuit 21, a subtracter 22, a γ multiplier 23 and an adder 24 are provided. The edge enhancement circuit 20 receives an image signal S_{GS} and performs edge enhancement processing by extracting a moving image region from an image.

The edge detection circuit 21 receives the image signal S_{GS}, compares a previous frame with a current frame as shown in FIGS. 7A and 7B, and determines whether the image has a moving image region and a still image region. If there is a moving image region (for example, an image A), edge enhancement processing is performed according to a movement speed of the moving image. Note that, in a case where the region is not an edge and where there is only a still image region (for example, an image B), the edge enhancement processing is not performed.

As shown in FIG. 8, an edge enhancement coefficient γ used to perform the edge enhancement processing is set to, for example, γ=1 between the movement speed=0 (still image) and a low movement speed A. Between the movement speed A and a high movement speed B, the edge enhancement coefficient γ is set to a linearly increasing value. In a region where the movement speed is higher than B, the edge enhancement coefficient γ is set to a constant value. Note that the edge enhancement coefficient γ is determined on the basis of, for example, a filter used in the edge detection circuit 21, image gradation data and the like.

The subtracter 22 receives current frame image data L1 and previous frame image data L0 outputted from the frame memory 1, performs subtraction processing, and outputs the result to the γ multiplier 23.

The γ multiplier 23 is provided between the subtracter 22 and the adder 24. The γ multiplier 23 receives a signal outputted from the subtracter 22, performs arithmetic processing by a multiplication factor of γ on the basis of the signal outputted from the subtracter 22, and outputs the result to the adder 24. Note that γ multiplication processing will be described in detail later.

The adder 24 is provided between the γ multiplier 23 and the frame memory 1. The adder 24 receives the previous frame image data L0 outputted from the frame memory 1 and the γ multiplication result outputted from the γ multiplier 23, performs addition processing, and outputs the result as edge enhancement image data Lc to the frame memory 1 and a subtracter 11.

The frame memory 1 receives the edge enhancement image data Lc, stores image information for each frame, and outputs the previous frame image data L0 to the correction data generation circuit 2 and the edge enhancement circuit 20.

In the correction data generation circuit 2, the subtracter 11, an α multiplier 12 and an adder 13 are provided. The subtracter 11 is provided between the frame memory 1 and the α multiplier 12. The subtracter 11 receives the previous frame image data L0 outputted from the frame memory 1 and the edge enhancement image data Lc outputted from the adder 24, performs subtraction processing, and outputs the result to the α multiplier 12. Note that, since the α multiplier 12 and the adder 13 are operated in the same manner as in Embodiment 1, description thereof will be omitted.

Here, when the edge enhancement coefficient is γ, a slope coefficient of a straight line is α, the previous frame image data is L0, the current frame image data is L1 and correction image data is L_{LAO}, the edge enhancement image data Lc is expressed as follows.
Lc=γ(L1−L0)+L0 Equation (2)

Specifically, subtraction processing of (L1−L0) is executed by the subtracter 22, γ multiplication processing of γ(L1−L0) is executed by the γ multiplier 23, and addition processing of γ(L1−L0)+L0 is executed by the adder 24, respectively. Thus, the edge enhancement image data Lc subjected to edge enhancement processing is generated.

Moreover, the correction image data L_{LAO} is expressed as follows.
L_{LAO}=α(Lc−L0)+L0 Equation (3)

Specifically, subtraction processing of (Lc−L0) is executed by the subtracter 11, α multiplication processing of α(Lc−L0) is executed by the α multiplier 12, and addition processing of α(Lc−L0)+L0 is executed by the adder 13, respectively. Thus, correction image data L_{LAO} for overdrive is generated.

Although, the edge enhancement coefficient γ is calculated by the edge detection circuit 21 in this embodiment, edge enhancement coefficient γ information may be inputted from outside or may be previously stored in a register or the like and be inputted therefrom.

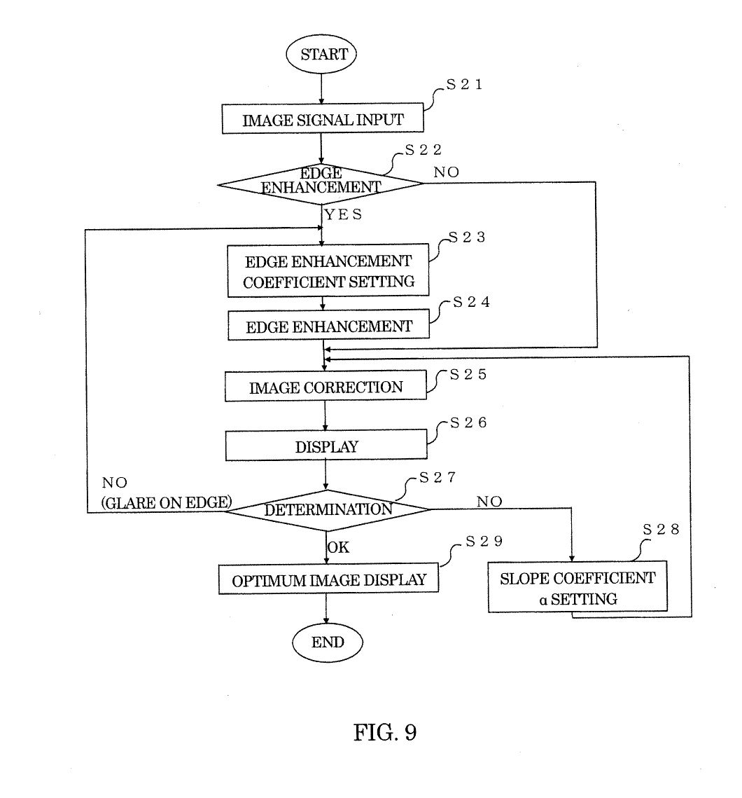

Next, with reference to FIG. 9, operations of the liquid crystal display device will be described. FIG. 9 is a flowchart showing the operations of the liquid crystal display device.

As shown in FIG. 9, first, an image signal S_{GS} is inputted to the edge enhancement circuit 20 (Step S21). Next, it is determined whether an image has a moving image region and a still image region and also whether or not edge enhancement processing is required (Step S22). For example, when the edge enhancement processing is not required as in the case of a still image, the processing advances to an image correction step of performing overdrive processing (Step S24). When there is a moving image region and the edge enhancement processing is required, an optimum edge enhancement coefficient γ is calculated by the edge enhancement circuit 20 according to a movement speed of a moving image (Step S23).

Subsequently, edge enhancement image data Lc is generated, which is subjected to the edge enhancement processing by the edge enhancement circuit 20 on the basis of the calculated edge enhancement coefficient γ, and the data is outputted to the frame memory 1 and the subtracter 11 (Step S24).

Thereafter, the edge enhancement image data Lc and previous frame image data L0 outputted from the frame memory 1 are inputted to the subtracter 11 in the correction data generation circuit 2, and subtraction processing is performed. The image data subjected to the subtraction processing is subjected to a multiplication processing using a predetermined slope coefficient α1, for example, by the α multiplier 12 in the correction data generation circuit 2. The previous frame image data L0 and the image data subjected to the α multiplication processing are inputted to the adder 13 in the correction data generation circuit 2, and addition processing is performed (Step S25).

Next, correction image data L_{LAO} for overdrive by the addition processing is inputted to the source driver 3. N channels of image data line information outputted from the source driver 3 and scanning line information outputted from the gate driver 4 are inputted to the display panel 5 to display an image thereon (Step S26).

Subsequently, it is determined whether the moving image is an optimum image for the viewer or an image to be further improved. For example, as a criterion, it is determined whether or not movement of the moving image is sharp and whether or not there is glare on the image edge (Step S27).

When the moving image is determined to be the optimum image, the image continues to be displayed (Step S29). In contrast, when it is determined that the movement of the moving image is not sharp, for example, and that the moving image is to be further improved, a slope coefficient α2 different from, and for example, larger than the predetermined slope coefficient α1 is inputted to the α multiplier 12 in the correction data generation circuit 2. Then, α multiplication processing is performed (Step S28). Thereafter, based on the image data subjected to the α multiplication processing, the image correction (Step S25) and the subsequent steps are carried out. The above steps are repeatedly carried out until the moving image is determined to be the optimum image for the viewer.

Alternatively, when it is determined that there is glare on the image edge, an edge enhancement coefficient γ2 is set, which is different from the calculated edge enhancement coefficient γ1 and is, for example, smaller than the edge enhancement coefficient γ1. Thereafter, by use of the edge enhancement coefficient γ2, the edge enhancement processing (Step S24) and the subsequent steps are carried out. The above steps are repeatedly carried out until the moving image is determined to be the optimum image for the viewer.

As described above, in the liquid crystal display device and the driving method thereof according to this embodiment, the frame memory 1, the correction data generation circuit 2, the source driver 3, the gate driver 4, the display panel 5 and the edge enhancement circuit 20 are provided. In the edge enhancement circuit 20, the edge detection circuit 21, the subtracter 22, the γ multiplier 23 and the adder 24 are provided. The edge enhancement circuit 20 performs edge enhancement processing when an image has a moving image region, and outputs the edge-enhanced image information to the frame memory 1 and the correction data generation circuit 2. In the correction data generation circuit 2, the subtracter 11, the α multiplier 12 and the adder 13 are provided. The correction data generation circuit 2 subjects moving image data to overdrive processing and, when the image signal S_{GS} is still image data, outputs the still image data directly to the source driver 3. The subtracter 11 receives the edge enhancement image data Lc and the previous frame image data L0 outputted from the frame memory 1 and performs subtraction processing. The α multiplier 12 receives a signal outputted from the subtracter 11 and performs arithmetic processing by a multiplication factor of α. The adder 13 receives the previous frame image data L0 outputted from the frame memory 1 and the α multiplication result outputted from the α multiplier 12, performs addition processing, and outputs the correction image data L_{LAO} for overdrive to the source driver 3.

Thus, in addition to the same effects as those in Embodiment 1, a clearer and less blurred moving image compared with that in Embodiment 1 can be provided by emphasizing only the edge of the moving image.

Note that, in this embodiment, the edge enhancement coefficient (γ) is set to take a linearly increasing value between the movement speeds (A) and (B). This setting may be arbitrarily changed such that instead of the linear increase, the edge enhancement coefficient is set to take an increasing value so as to form a quadratic curve, for example.

### Embodiment 4

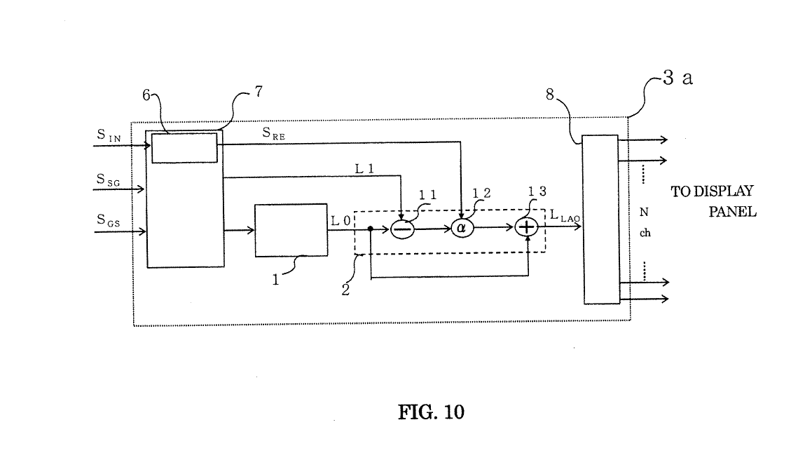

Next, with reference to the drawings, description will be given of a liquid crystal display device according to Embodiment 4 of the present invention. FIG. 10 is a block diagram showing a source driver for liquid crystal display. In this embodiment, a correction data generation circuit is provided in the source driver.

Hereinafter, the same constituent parts as those in Embodiment 1 will be denoted by the same reference numerals, and description thereof will be omitted. Only different parts will be described below.

As shown in FIG. 10, a source driver 3a includes a frame memory 1, a correction data generation circuit 2, an input circuit/control circuit 7 and an output circuit 8. The source driver 3a is used in a portable telephone. Here, the frame memory 1 functions as a display memory for one screen-display to reduce power consumption and as a frame memory compatible with an overdrive technique.

In the input circuit/control circuit 7, a register 6 is provided. The input circuit/control circuit 7 receives an image signal S_{GS} and a control signal S_{SG}, outputs image data information to the frame memory 1, and outputs current frame image data L1 to a subtracter 11 in the correction data generation circuit 2.

The register 6 is provided in the input circuit/control circuit 7, receives an input signal S_{IN} including slope coefficient α information inputted from outside the liquid crystal display device 30a, and stores the information. Thereafter, the register 6 outputs a register output signal S_{RE} including the slope coefficient α information to an α multiplier 12. Upon reception of the slope coefficient α inputted from outside via the register 6, the α multiplier 12 performs α multiplication processing by use of the slope coefficient α.

The output circuit 8 receives correction image data L_{LAO} for overdrive outputted from the correction data generation circuit 2, and outputs voltage information to N channels of data lines in a display panel.

As described above, in the liquid crystal display device and a driving method thereof according to this embodiment, the frame memory 1, the correction data generation circuit 2, the input circuit/control circuit 7 and the output circuit 8 are provided in the source driver 3a. In the correction data generation circuit 2, the subtracter 11, the α multiplier 12 and an adder 13 are provided. The correction data generation circuit 2 subjects moving image data to overdrive processing and, when the image signal S_{GS} is still image data, outputs the still image data directly to the output circuit 8. The subtracter 11 receives the current frame image data L1 and previous frame image data L0 outputted from the frame memory 1 and performs subtraction processing. The α multiplier 12 receives a signal outputted from the subtracter 11 and performs arithmetic processing by a multiplication factor of α. The adder 13 receives the previous frame image data L0 outputted from the frame memory 1 and the α multiplication result outputted from the α multiplier 12, performs addition processing, and outputs the correction image data L_{LAO} for overdrive to the output circuit 8. The register 6 is provided in the input circuit/control circuit 7, receives the input signal S_{IN} including the slope coefficient α information inputted from outside, and stores the information. Thereafter, the register 6 outputs the register output signal S_{RE} including the slope coefficient α information to the α multiplier 12. Upon reception of the slope coefficient α inputted from outside via the register 6, the α multiplier 12 performs α multiplication processing by use of the slope coefficient α.

Thus, without using the LUT, the moving image can be displayed on the liquid crystal display panel at a high response speed. In addition, it is no longer necessary to perform an operation of writing to a memory, such as a ROM, every time a new liquid crystal display panel is designed. To be specific, the necessity is eliminated for writing to a memory an enormous amount of correction data to match the number of gradations of image data by measuring optimum correction data. Moreover, since output terminals to correspond with the LUT are no longer required, an increase in the number of output terminals can be avoided. Furthermore, since the circuit configuration can be simplified compared with the LUT method, power consumption can be lowered. Also, it is possible to appropriately set the slope coefficient α so as to optimize the movement of the moving image by looking at a liquid crystal display screen from outside. Thus, time required to measure correction data can be shortened, and redesigning is not required for each liquid crystal material or each liquid crystal panel. Furthermore, since the correction data generation circuit 2 and the register 6 are both provided in the source driver 3a, the number of parts can be reduced in the liquid crystal display device. Therefore, the liquid crystal display device can be reduced in weight and size.

Note that, although the register 6 is provided in the input circuit/control circuit 7 in this embodiment, the register 6 may alternatively be provided outside the input circuit/control circuit 7.

### Embodiment 5

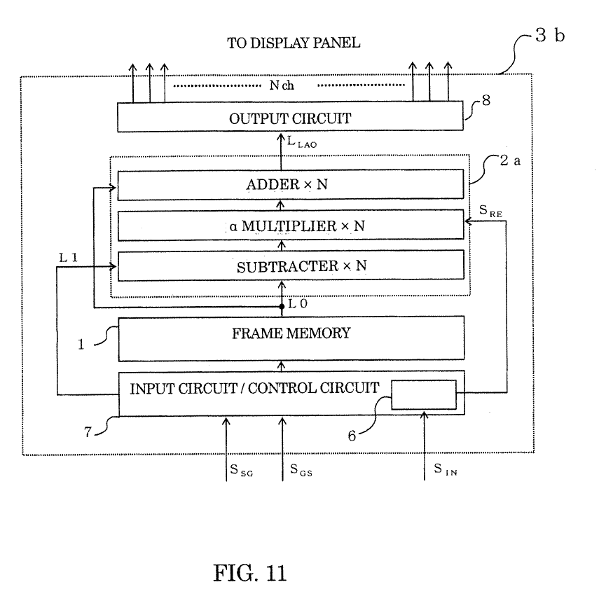

Next, with reference to the drawings, description will be given of a liquid crystal display device according to Embodiment 5 of the present invention. FIG. 11 is a block diagram showing a source driver for liquid crystal display. In this embodiment, a plurality of adders, α multipliers and subtracters are provided in a correction data generation circuit in the source driver.

Hereinafter, the same constituent parts as those in Embodiment 4 will be denoted by the same reference numerals, and description thereof will be omitted. Only different parts will be described below.

As shown in FIG. 11, a source driver 3b includes a frame memory 1, a correction data generation circuit 2a, an input circuit/control circuit 7 and an output circuit 8. The source driver 3b is used in a portable telephone. Here, in the case where a liquid crystal display panel has, for example, a QVGA screen, the number of pixels is set to 240 (RGB)×320 and the number of output terminals in the source driver 3b is set to 240 (RGB)×3=720. Since the LUT method is not used, an increase in the number of output terminals can be avoided. Moreover, when image data has 6 bits, the capacity of the frame memory 1 is set to 240×3×320×6 bits.

In the correction data generation circuit 2a, N=720 pieces of subtracters, N=720 pieces of α multipliers and N=720 pieces of adders are provided. Accordingly, overdrive processing is carried out for each of N=720 pieces.

The output circuit 8 receives each correction image data L_{LAO} for overdrive outputted from N pieces of adders in the correction data generation circuit 2a. Then, the output circuit 8 outputs voltage information to data lines in the display panel. Here, the number N of output terminals in the output circuit 8 does not necessarily correspond to 720, the number of channels.

As described above, in the liquid crystal display device according to this embodiment, the frame memory 1, the correction data generation circuit 2a, the input circuit/control circuit 7 and the output circuit 8 are provided in the source driver 3b. In the correction data generation circuit 2a, N pieces of the subtracters, N pieces of the α multipliers and N pieces of the adders are provided. The correction data generation circuit 2a subjects moving image data to overdrive processing and, when an image signal S_{GS} is still image data, outputs the still image data directly to the output circuit 8. A register 6 is provided in the input circuit/control circuit 7, which receives an input signal S_{IN} including slope coefficient α information inputted from outside, and stores the information. Thereafter, the register 6 outputs a register output signal S_{RE} including the slope coefficient α information to N pieces of the α multipliers. Upon receipt of the slope coefficient α inputted from outside via the register 6, N pieces of the α multipliers perform α multiplication processing by use of the slope coefficient α. Thus, the same effects as those in Embodiment 4 are achieved.

Note that, although the register 6 is provided in the input circuit/control circuit 7 in this embodiment, the register 6 may alternatively be provided outside the input circuit/control circuit 7.

### Embodiment 6

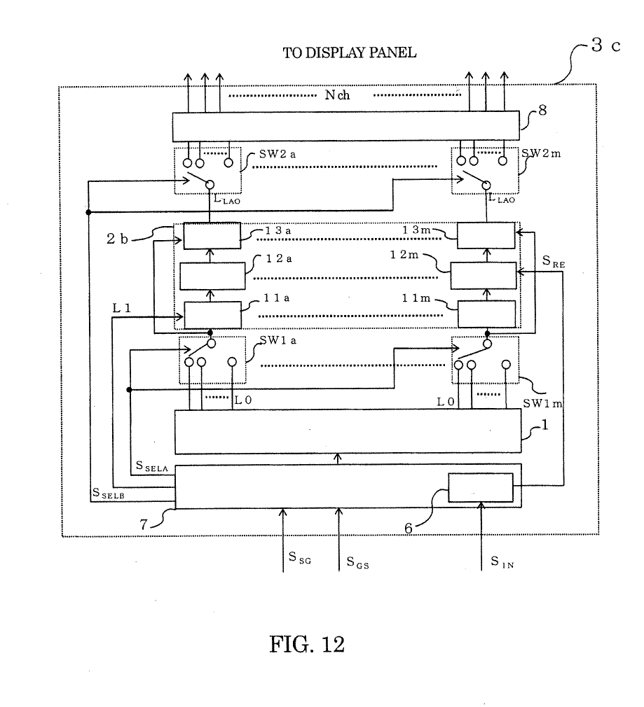

Next, with reference to the drawings, description will be given of a liquid crystal display device according to Embodiment 6 of the present invention. FIG. 12 is a block diagram showing a source driver for liquid crystal display. In this embodiment, a plurality of adders, α multipliers and subtracters are provided in a correction data generation circuit in the source driver, and the number thereof is set smaller than that in Embodiment 5.

Hereinafter, the same constituent parts as those in Embodiment 4 will be denoted by the same reference numerals, and description thereof will be omitted. Only different parts will be described below.

As shown in FIG. 12, a source driver 3c includes a frame memory 1, a correction data generation circuit 2b, an input circuit/control circuit 7, switching circuits SW1a to SW1m, switching circuits SW2a to SW2m and an output circuit 8. The source driver 3c is used in a portable telephone.

Here, the number of the switching circuits SW1a to SW1m is m, all having the same structure. The number of the switching circuits SW2a to SW2m is m, all having the same structure. The number of subtracters 11a to 11m included in the correction data generation circuit 2b is m, all having the same structure. The number of α multipliers 12a to 12m included in the correction data generation circuit 2b is m, all having the same structure. The number of adders 13a to 13m included in the correction data generation circuit 2b is m, all having the same structure.

Moreover, while the number of output terminals in the source driver 3c is set to, for example, N=720, here, the number of each of the switching circuits SW1, the switching circuits SW2, the subtracters 11, the α multipliers 12 and the adders 13 is set to m=72 ( 1/10 of N=720, the number of output terminals). The switching circuits SW1 and SW2 function as image data selection means.

The input circuit/control circuit 7 receives an image signal S_{GS} and a control signal S_{SG}, outputs image data information to the frame memory 1, and outputs current frame image data L1 to each of the subtracters 11a to 11m in the correction data generation circuit 2b. Thereafter, the control circufit outputs a selection signal S_{SELA} for controlling operations of the switching circuits SW1a to SW1m and a selection signal S_{SELB} for controlling operations of the switching circuits SW2a to SW2m.

A register 6 is provided in the input circuit/control circuit 7, receives an input signal S_{IN} including slope coefficient α information inputted from outside the liquid crystal display device 30c, and stores the information. Thereafter, the register 6 outputs a register output signal S_{RE} including the slope coefficient α information to each of the α multipliers 12a to 12m.

The frame memory 1 is provided between the input circuit/control circuit 7 and m pieces of the switching circuits SW1, and outputs 10 pieces of previous frame image data L0 to each of m pieces of the switching circuits SW1.

The switching circuit SW1a is formed of a SP10T switch and is provided between the frame memory 1 and the subtracter 11a. The switching circuit SW1a receives 10 pieces of the previous frame image data L0 outputted from the frame memory 1, selects any one piece of the previous frame image data L0 on the basis of the selection signal S_{SELA}, and outputs the selected data to the subtracter 11a and the adder 13a.

The subtracter 11a is provided between the switching circuit SW1a as well as the frame memory 1 and the α multiplier 12a. The subtracter 11a receives current frame image data L1 and the previous frame image data L0 selectively outputted from the switching circuit SW1a, performs subtraction processing, and outputs the result to the α multiplier 12a.

The α multiplier 12a is provided between the subtracter 11a and the adder 13a, subjects a signal outputted from the subtracter 11a to arithmetic processing by a multiplication factor of α, and outputs the result to the adder 13a.

The adder 13a is provided between the α multiplier 12a and the switching circuit SW2a. The adder 13a receives the previous frame image data L0 selectively outputted from the switching circuit SW1a and the α multiplication result outputted from the α multiplier 12a, performs addition processing, and outputs the result as correction image data L_{LAO} to the switching circuit SW2a.

The switching circuit SW2a is formed of a SP10T switch and is provided between the adder 13a and the output circuit 8. The switching circuit SW2a receives the correction image data L_{LAO} outputted from the adder 13a, and selectively outputs the received data to any one of 10 input terminals provided in the output circuit 8, on the basis of the selection signal S_{SELB}. Here, in the output circuit 8, at least 10 m (10×72=720) input terminals are provided.

The switching circuit SW1m is formed of a SP10T switch and is provided between the frame memory 1 and the subtracter 11m. The switching circuit SW1m receives 10 pieces of the previous frame image data L0 outputted from the frame memory 1, selects any one piece of the previous frame image data L0 on the basis of the selection signal S_{SELA}, and outputs the selected data to the subtracter 11m and the adder 13m.

The subtracter 11m is provided between the switching circuit SW1m as well as the frame memory 1 and the α multiplier 12m. The subtracter 11m receives the current frame image data L1 and the previous frame image data L0 selectively outputted from the switching circuit SW1m, performs subtraction processing, and outputs the result to the α multiplier 12m.

The α multiplier 12m is provided between the subtracter 11m and the adder 13m, subjects a signal outputted from the subtracter 11m to arithmetic processing by a multiplication factor of α, and outputs the result to the adder 13m.

The adder 13m is provided between the α multiplier 12m and the switching circuit SW2m. The adder 13m receives the previous frame image data L0 selectively outputted from the switching circuit SW1m and the α multiplication result outputted from the α multiplier 12m, performs addition processing, and outputs the result as correction image data L_{LAO} to the switching circuit SW2m.

The switching circuit SW2m is formed of a SP10T switch and is provided between the adder 13m and the output circuit 8. The switching circuit SW2m receives the correction image data L_{LAO} outputted from the adder 13m, and selectively outputs the received data to any one of 10 input terminals provided in the output circuit 8, on the basis of the selection signal S_{SELB}.

The output circuit 8 receives the correction image data L_{LAO} for overdrive outputted from the respective switching circuits SW2a to SW2m, and outputs voltage information to data lines in the display panel. Note that the number N of output terminals in the output circuit 8 does not necessarily correspond to 720, the number of channels.

As described above, in the liquid crystal display device according to this embodiment, the frame memory 1, the correction data generation circuit 2b, the input circuit/control circuit 7, the switching circuits SW1a to SW1m, the switching circuits SW2a to SW2m and the output circuit 8 are provided in the source driver 3c. Each of m pieces of the switching circuits SW1 receives 10 pieces of the previous frame image data L0 outputted from the frame memory 1, and then selects any one piece of the previous frame image data L0 on the basis of the selection signal S_{SELA}. Subsequently, each of m pieces of the switching circuits SW1 outputs the selected data to each of the subtracters 11 and the adders 13 corresponding to the switching circuits SW1. In the correction data generation circuit 2b, m pieces of the subtracters, m pieces of the α multipliers and m pieces of the adders are provided. The correction data generation circuit 2b subjects moving image data to overdrive processing and, when an image signal S_{GS} is still image data, outputs the still image data directly to the output circuit 8. A register 6 is provided in the input circuit/control circuit 7, receives an input signal S_{IN} including slope coefficient α information inputted from outside, and stores the information. Thereafter, the register 6 outputs a register output signal S_{RE} including the slope coefficient α information to m pieces of the α multipliers. Upon reception of the slope coefficient α inputted from outside via the register 6, m pieces of the α multipliers perform α multiplication processing by use of the slope coefficient α.

Each of m pieces of the switching circuits SW2 receives the correction image data L_{LOA} outputted from each of m pieces of the adders 13 and corresponding to each of the switching circuits SW2, and selectively outputs the received data to any one of the 10 input terminals provided in the output circuit 8 on the basis of the selection signal S_{SELB}.

Thus, besides the same effects as those in Embodiment 4, the number of the subtracters, α multipliers and adders included in the correction data generation circuit 2b can be reduced, allowing the circuit configuration in the source driver 3c to be simplified.

Note that, in this embodiment, while the number of output terminals in the source driver 3c is set to 720, the number of each of the switching circuits SW1, the switching circuits SW2, the subtracters 11, the α multipliers 12 and the adders 13 is set to 72 ( 1/10 of the number of output terminals). However, the output terminals and the respective parts may be provided by a different ratio. For example, the number of each of the above parts may be set to ⅕ of the number of output terminals. Moreover, although m pieces of each of the switching circuits SW1 and SW2 formed of SP10T switches are provided in this embodiment, the configurations may be changed arbitrarily.

### Embodiment 7

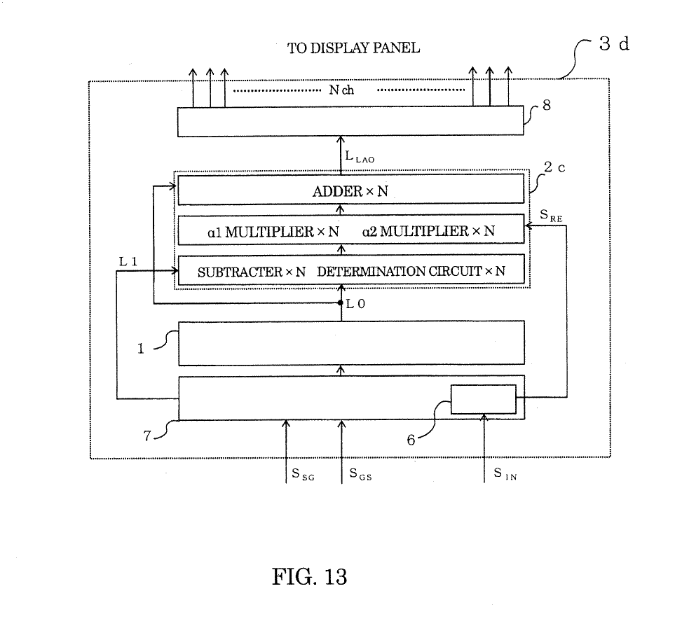

Next, with reference to the drawings, description will be given of a liquid crystal display device according to Embodiment 7 of the present invention. FIG. 13 is a block diagram showing a source driver for liquid crystal display. In this embodiment, a plurality of two kinds of α multipliers and a plurality of positive/negative determination circuits are provided in a correction data generation circuit in the source driver.

Hereinafter, the same constituent parts as those in Embodiment 4 will be denoted by the same reference numerals, and description thereof will be omitted. Only different parts will be described below.

As shown in FIG. 13, a source driver 3d includes a frame memory 1, a correction data generation circuit 2c, an input circuit/control circuit 7 and an output circuit 8. The source driver 3d is used in a portable telephone.

The input circuit/control circuit 7 receives an image signal S_{GS} and a control signal S_{SG}, outputs image data information to the frame memory 1, and outputs current frame image data L1 to the correction data generation circuit 2c.

A register 6 is provided in the input circuit/control circuit 7, receives an input signal S_{IN} including slope coefficient α information inputted from outside the liquid crystal display device 30d, and stores the information. Thereafter, the register 6 outputs a register output signal S_{RE} including the slope coefficient α information to each of N pieces of α1 multipliers and each of N pieces of α2 multipliers.

The correction data generation circuit 2c is provided between the frame memory 1 and the output circuit 8. In the correction data generation circuit 2c, N pieces of subtracters, N pieces of positive/negative determination circuits, N pieces of the α1 multipliers, N pieces of the α2 multipliers and N pieces of adders are provided. The α1 multipliers perform α multiplication by use of a slope coefficient α1 and the α2 multipliers perform α multiplication by use of a slope coefficient α2.

Here, image data in a region where a relationship between previous frame image data L0 and the current frame image data L1 is expressed as follows is α-multiplied by use of the slope coefficient α1.
(L1−L0)>0 Expression (4)

Moreover, image data in a region where the relationship is expressed as follows is α-multiplied by use of the slope coefficient α2.
(L1−L0)<0 Expression (5)

Here, assumed is a case where a relationship with (L_{LAO}−L0) differs for example, between a region where (L1−L0) is positive and a region where (L1−L0) is negative, and where the relationship between (L1−L0) and (L_{LAO}−L0) is a weak correlation. In this case, overdrive processing is carried out by use of two different slope coefficients, a1 and a2. Specifically, the slope coefficient α1 is obtained from linear approximation of the region where (L1−L0) is positive and the slope coefficient α2 is obtained from linear approximation of the region where (L1−L0) is negative. Thus, a sharp moving image can be displayed at a high response speed.

Each of the positive/negative determination circuits determines whether the value of (L1−L0) is positive or negative. On the basis of a signal outputted from the positive/negative determination circuit, selection between the α1 multiplier and the α2 multiplier is made.

In the case of the slope coefficient α1, the previous frame image data L0 and the α-multiplied image data outputted from the α1 multipliers are inputted to the adders, and addition processing is performed. Meanwhile, in the case of the slope coefficient α2, the previous frame image data L0 and the α-multiplied image data outputted from the α2 multipliers are inputted to the adders, and addition processing is performed.

The output circuit 8 receives each of the correction image data L_{LAO} for overdrive outputted from N pieces of the adders, and outputs voltage information to data lines in the display panel.

As described above, in the liquid crystal display device according to this embodiment, the frame memory 1, the correction data generation circuit 2c, the input circuit/control circuit 7 and the output circuit 8 are provided in the source driver 3d. In the correction data generation circuit 2c, N pieces of the subtracters, N pieces of the positive/negative determination circuits, N pieces of the α1 multipliers, N pieces of the α2 multipliers and N pieces of the adders are provided. The correction data generation circuit 2c performs the overdrive processing by use of the slope coefficient α1 in the case of the region where (L1−L0) is positive and by use of the slope coefficient α2 in the case of the region where (L1−L0) is negative.

Thus, In addition to the same effects as those in Embodiment 4, the following effect is achieved. Specifically, even if there is a weak correlation between (L1−L0) and (L_{LAO}−L0), the optimum slope coefficient α is used for each of the region where (L1−L0) is positive and the region where (L1−L0) is negative. Thus, a sharp moving image can be displayed at a high response speed.

Note that, although the slope coefficient α is classified into two types in this embodiment, the slope coefficient α is not necessarily limited thereto but may be further classified into three or four types.

### Embodiment 8

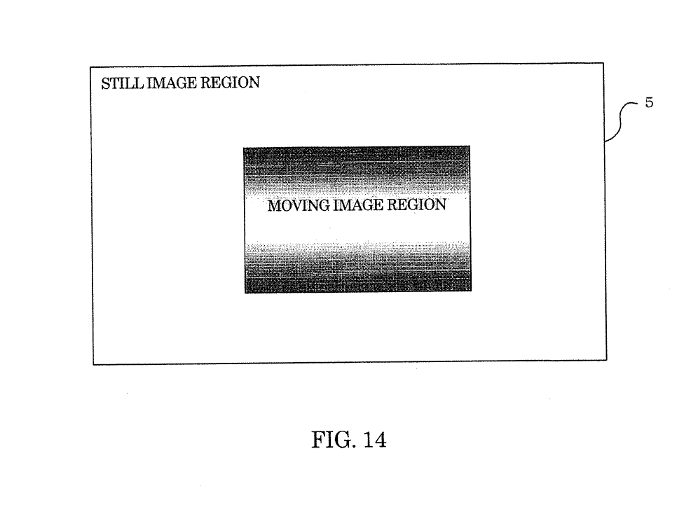

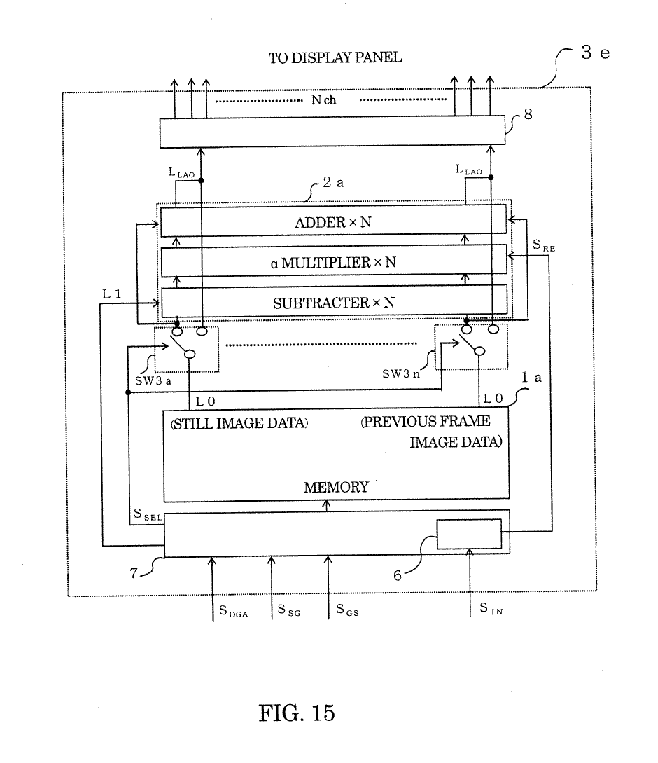

Next, with reference to the drawings, description will be given of a liquid crystal display device and a driving method thereof according to Embodiment 8 of the present invention. FIG. 14 is a view showing regions of a still image and regions of a moving image which are displayed on a display panel. FIG. 15 is a block diagram showing a source driver for liquid crystal display. In this embodiment, a plurality of switching circuits for switching between a still image and a moving image are provided.

Hereinafter, the same constituent parts as those in Embodiment 4 will be denoted by the same reference numerals, and description thereof will be omitted. Only different parts will be described below.

When a moving image and a still image are simultaneously displayed on a display panel 5, as shown in FIG. 14, the overdrive technique is used for the moving image region displayed in a part of the region of the display panel 5, and the overdrive technique is not used for the still image region displayed in the other region thereof.

As shown in FIG. 15, a source driver 3e includes a memory 1a, a correction data generation circuit 2a, an input circuit/control circuit 7, switching circuits SW3a to SW3n and an output circuit 8. The source driver 3e is used in a portable telephone. Here, the number of the switching circuits SW3a to SW3n is N, each having the same structure, functioning as image data selection means.

The input circuit/control circuit 7 receives an image signal S_{GS}, a control signal S_{SG} and a moving image region address-designation signal S_{DGA} and outputs image data information to the memory 1a. Then, the control circuit outputs current frame image data L1 to each of N pieces of subtracters in the correction data generation circuit 2a. Thereafter, the control circuit outputs N selection signals S_{SEL} for controlling operations of the switching circuits SW3a to SW3n, and designates an address of moving image data on the basis of the moving image region address-designation signal S_{DGA}.

A register 6 is provided in the input circuit/control circuit 7, receives an input signal S_{IN} including slope coefficient α information inputted from outside the liquid crystal display device 30e, and stores the information. Thereafter, the register 6 outputs a register output signal S_{RE} including the slope coefficient α information to each of N pieces of α multipliers.

The memory 1a is provided between the input circuit/control circuit 7 and N pieces of the switching circuits SW3, and outputs previous frame image data L0 of moving images and still images to each of N pieces of the switching circuits SW3. Here, a region of the memory 1a for storing moving image data is used as a frame memory for retaining the previous frame image data, and a region of the memory 1a for storing still image data is used as a normal display memory.

The switching circuit SW3a is formed of an SPDT switch and is provided between the memory 1a and the first subtracter in the correction data generation circuit 2a. The switching circuit SW3a receives the previous frame image data (moving image data) L0 and the still image data outputted from the memory 1a, and then selects any one of the image data on the basis of the selection signal S_{SEL}.

When the image data is a still image, the still image data outputted from the switching circuit SW3a is outputted directly to the output circuit 8. In contrast, when the image data is a moving image, the moving image data, which address is designated on the basis of the moving image region address-designation signal S_{DGA} and which is selected by the switching circuit SW3a, is corrected by the correction data generation circuit 2a. Thus, the image data is outputted as correction image data L_{LAO} to the output circuit 8.

The Nth switching circuit SW3n is formed of an SPDT switch and is provided between the memory 1a and the Nth subtracter in the correction data generation circuit 2a. The switching circuit SW3n receives the previous frame image data (moving image data) L0 and the still image data outputted from the memory 1a, and then selects any one of the image data on the basis of the selection signal S_{SEL}.

When the image data is a still image, the still image data outputted from the Nth switching circuit SW3n is outputted directly to the output circuit 8. In contrast, when the image data is a moving image, the moving image data, which address is designated on the basis of the moving image region address-designation signal S_{DGA} and which is selected by the Nth switching circuit SW3n, is corrected by the correction data generation circuit 2a. Thus, the image data is outputted as correction image data L_{LAO} to the output circuit 8.

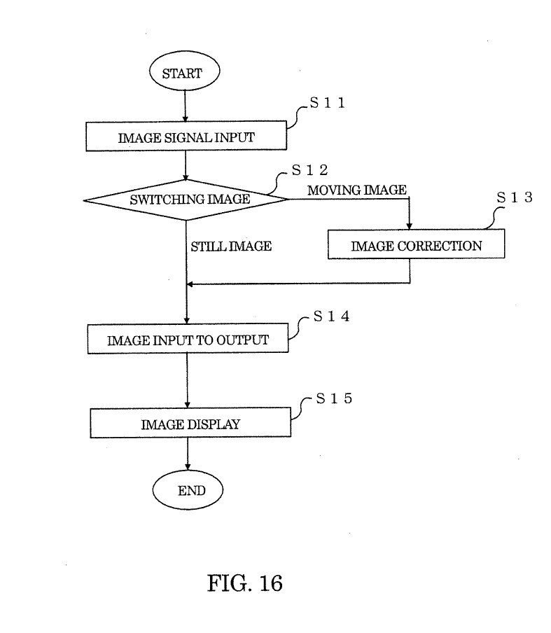

Next, with reference to FIG. 16, operations of the liquid crystal display device will be described. FIG. 16 is a flowchart showing the operations of the liquid crystal display device.

As shown in FIG. 16, first, an image signal S_{GS} is inputted to the memory 1a, and image data is stored therein (Step S11). Next, on the basis of a selection signal S_{SEL} each of the switching circuits SW3 selects between moving image data and still image data outputted from the memory 1a. (Step S12).

When the image data outputted from the memory 1a is a moving image, moving image data, which address is designated on the basis of a moving image region address-designation signal S_{DGA} and which is selected by the switching circuit SW3, is corrected by the correction data generation circuit 2a. Thus, the image data is outputted as correction image data L_{LAO} to the output circuit 8 (Step S13). In contrast, when the image data outputted from the memory 1a is a still image, the still image data selected by the switching circuit SW3 is outputted directly to the output circuit 8 (Step S14).

Subsequently, the correction image data L_{LAO} outputted from the correction data generation circuit 2a and the still image data selectively outputted from the switching circuit SW3 are inputted to the output circuit 8. Accordingly, image data line information outputted from the output circuit and scanning line information outputted from the gate driver are inputted to the liquid crystal display panel to display an image (Step S15).

As described above, in the liquid crystal display device and the driving method thereof according to this embodiment, the memory 1a, the correction data generation circuit 2a, the input circuit/control circuit 7, the switching circuits SW3a to SW3n and the output circuit 8 are provided in the source driver 3e. The input circuit/control circuit 7 receives the image signal S_{GS}, the control signal S_{SG} and the moving image region address-designation signal S_{DGA}. Subsequently, the control circuit outputs the image data information to the memory 1a, and outputs the current frame image data L1 to each of N pieces of the subtracters in the correction data generation circuit 2a. The register 6 receives the input signal S_{IN} including the slope coefficient α information inputted from outside, and stores the information. The memory 1a outputs the previous frame image data L0 of moving images and still images to each of N pieces of the switching circuits SW3. Each of N pieces of the switching circuits SW3 receives the previous frame image data (moving image data) L0 and the still image data outputted from the memory 1a and selects any one of the image data on the basis of the selection signal S_{SEL}. When the image data is a still image, the still image data outputted from each of N pieces of the switching circuits SW3 is outputted directly to the output circuit 8. Meanwhile, when the image data is a moving image, the moving image data, which address is designated on the basis of the moving image region address designation signal S_{DGA} and which is selected by each of N pieces of the switching circuits SW3, is corrected by the correction data generation circuit 2a. Thus, the image data is outputted as the correction image data L_{LAO} to the output circuit 8.

Consequently, besides the same effects as those in Embodiment 4, sharp moving and still images can be simultaneously displayed on the liquid crystal display panel at a high response speed.

### Embodiment 9

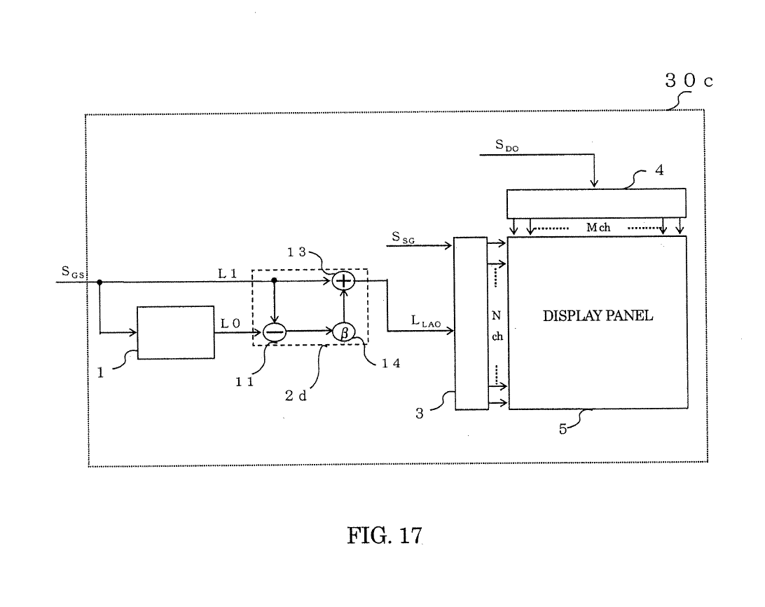

Next, with reference to the drawings, description will be given of a liquid crystal display device according to Embodiment 9 of the present invention. FIG. 17 is a schematic block diagram showing the liquid crystal display device. In this embodiment, the configuration of the correction data generation circuit is modified.

Hereinafter, the same constituent parts as those in Embodiment 1 will be denoted by the same reference numerals, and description thereof will be omitted. Only different parts will be described below.

As shown in FIG. 17, a liquid crystal display device 30c includes a frame memory 1, a correction data generation circuit 2d, a source driver 3, a gate driver 4 and a display panel 5. The liquid crystal display device 30c is used in a portable telephone.

In the correction data generation circuit 2d, a subtracter 11, an adder 13 and a β multiplier 14 are provided. The correction data generation circuit 2d is provided between the frame memory 1 and the source driver 3, receives moving image data, performs arithmetic processing and outputs correction image data L_{LAO} for overdrive to the source driver 3. Note that, when an image signal S_{GS} is still image data, the correction data generation circuit 2d outputs the still image data directly to the source driver 3.

The subtracter 11 is provided between the frame memory 1 and the β multiplier 14. The subtracter 11 receives current frame image data L1 and the previous frame image data L0 outputted from the frame memory 1, performs subtraction processing, and outputs the result to the β multiplier 14.

The β multiplier 14 is provided between the subtracter 11 and the adder 13. The β multiplier 14 receives a signal outputted from the subtracter 11, performs arithmetic processing, and outputs the result to the adder 13. Note that β multiplication processing will be described in detail later.

The adder 13 is provided between the β multiplier 14 and the source driver 3. The adder 13 receives the current frame image data L1 and the β multiplication result outputted from the β multiplier 14, performs addition processing, and outputs the result as the correction image data L_{LAO} to the source driver 3.

The source driver 3 is provided between the adder 13 and the display panel 5. The source driver 3 receives the correction image data L_{LAO} outputted from the adder 13 and a control signal S_{SG}, and supplies image data that is voltage information to N channels of data lines in the display panel 5. Note that, when the image signal S_{GS} is still image data, the source driver 3 receives the uncorrected still image data and the control signal S_{SG}, and then supplies the image data that is the voltage information to the N channels of data lines in the display panel 5.

Here, as an overdrive signal, (L_{LAO}−L1) is used instead of (L_{LAO}−L0). In this event, when a slope coefficient of a straight line is β, the previous frame image data is L0, the current frame image data is L1 and the correction image data is L_{LAO}, the following equation is established.
L_{LAO}−L1=β(L1−L0) Equation (6)

The following is a modification of Equation (6).
L_{LAO}=β(L1−L0)+L1 Equation (7)

Specifically, subtraction processing of (L1−L0) is executed by the subtracter 11, β multiplication processing of β(L1−L0) is executed by the β multiplier 14, and addition processing of β(L1−L0)+L1 is executed by the adder 13, respectively. Thus, the correction image data L_{LAO} for overdrive is generated.

As described above, in the liquid crystal display device of this embodiment, the frame memory 1, the correction data generation circuit 2d, the source driver 3, the gate driver 4 and the display panel 5 are provided. In the correction data generation circuit 2d, the subtracter 11, the adder 13 and the β multiplier 14 are provided. The correction data generation circuit 2d subjects moving image data to overdrive processing and, when the image signal S_{GS} is still image data, outputs the still image data directly to the source driver 3. The subtracter 11 receives the current frame image data L1 and the previous frame image data L0 outputted from the frame memory 1 and performs subtraction processing. The β multiplier 14 receives the signal outputted from the subtracter 11 and performs arithmetic processing by a multiplication factor of β. The adder 13 receives the current frame image data L1 and the β multiplication result outputted from the β multiplier 14, performs addition processing, and outputs the correction image data L_{LAO} for overdrive to the source driver 3. Thus, the same effects as those in Embodiment 1 are achieved.

The present invention is not limited to the foregoing embodiments. Various changes may be made if not departed from the scope of the invention.

The following examples are possible changes to be made on the foregoing embodiments. The overdrive technique using the correction data generation circuit is applied to a portable telephone as a mobile terminal in the embodiments. The overdrive technique can be applied to a display (display device) for a personal computer, a TV, on-vehicle equipment, a measuring instrument and the like. Moreover, in Embodiment 3, the overdrive processing is executed after the edge enhancement processing is performed for the moving image. This edge enhancement processing is not limited to Embodiment 3 but can also be applied to the other embodiments. Furthermore, in Embodiment 9, the signal outputted from the subtracter 11 is subjected to β multiplication processing using a slope coefficient β by the β multiplier 14. However, a plurality of β multipliers may be provided in the correction data generation circuit, β multiplication processing may be performed by the respective β multipliers using different slope coefficients Bβ, and thus the overdrive processing may be performed. Moreover, a register may be provided in Embodiment 9, and slope coefficient β information may be inputted from outside through the register to the β multiplier.

What is claimed is:

1. A liquid crystal display device comprising:
a memory which receives an image signal, and which stores image data; and
a correction data generation circuit that performs overdrive processing when the image data is a moving image, the correction data generation circuit having:
a subtracter which performs subtraction processing after receiving previous frame image data outputted from the memory and current frame image data;
a multiplier which performs multiplication processing by a predetermined multiplication factor after receiving a result of subtraction by the subtracter; and
an adder which performs addition processing after receiving a result of multiplication by the multiplier and the current frame image data or the previous frame image data outputted from the memory.

2. A liquid crystal display device comprising:
a memory which receives an image signal and stores image data;
a slope coefficient storage which stores a slope coefficient inputted from outside; and
a correction data generation circuit which performs overdrive processing when the image data is a moving image, and which directly outputs the image data as still image data when the image data is a still image, the correction data generation circuit having:
a subtracter which performs subtraction processing after receiving current frame image data and previous frame image data stored in the memory;
a multiplier which performs multiplication processing by use of the slope coefficient after receiving a result of subtraction by the subtracter; and
an adder which performs addition processing after receiving a result of multiplication by the multiplier and the current frame image data or the previous frame image data outputted from the memory.

3. The liquid crystal display device according to claim 2, wherein the slope coefficient storage is a register which stores the slope coefficient.

4. A liquid crystal display device comprising:
a frame memory which receives an image signal and stores image data;
a slope coefficient storage which stores a plurality of different slope coefficients inputted from outside; and
a correction data generation circuit which performs overdrive processing when the image data is a moving image and which directly outputs the image data as still image data when the image data is a still image, the correction data generation circuit having:
a subtracter which subtracts previous frame image data stored in the frame memory from current frame image data;
a determination circuit which determines and selects one of the plurality of different slope coefficients according to a result of the subtraction processing;
a multiplier which receives a result of subtraction by the subtracter, and performs multiplication processing by use of the slope coefficient selected by the determination circuit; and
an adder which receives a result of multiplication by the multiplier and the previous frame image data stored in the frame memory to perform addition processing.

5. The liquid crystal display device according to claim 4, wherein the slope coefficient storage is a register which stores the slope coefficients.

6. A liquid crystal display device comprising:
an edge enhancement circuit which receives an image signal, and which performs edge-enhancement processing for a moving image portion when the image has a moving image region;
a memory which receives edge enhancement image data outputted from the edge enhancement circuit after edge enhancement processing, and which stores the image data; and
a correction data generation circuit which performs overdrive processing when the image data is a moving image, the correction data generation circuit having:
a subtracter which performs subtraction processing after receiving the edge enhancement image data and the previous frame image data outputted from the memory;
a multiplier which performs multiplication processing by a predetermined multiplication factor after receiving a result of subtraction by the subtracter; and
an adder which performs addition processing after receiving a result of multiplication by the multiplier and the previous frame image data outputted from the memory or the edge enhancement image data.

7. A method for driving a liquid crystal display device, comprising:
storing image data in a frame memory;
subtracting previous frame moving image data stored in the frame memory from current frame moving image data;
multiplying the moving image data after the subtraction by a first slope coefficient;
obtaining correction moving image data for overdrive by adding the moving image data after the multiplication and the previous frame moving image data stored in the frame memory;
displaying moving image data from the correction moving image data;
determining whether the displayed moving image is an optimum image or an image to be further improved; and
performing subtraction, multiplication and addition processing by use of a second slope coefficient different from the first slope coefficient, when the displayed moving image is determined to be the image to be further improved, and repeating the above processing until the moving image becomes the optimum image.

8. A method for driving a liquid crystal display device, comprising:
performing edge-enhancement processing for a moving image portion when image data has a moving image region;
storing the edge-enhanced moving image data in a frame memory;
subtracting previous frame moving image data stored in the frame memory from the edge-enhanced moving image data;
multiplying the moving image data after the subtraction by use of a first slope coefficient;
obtaining correction moving image data for overdrive by adding the multiplied moving image data and the previous frame moving image data stored in the frame memory;
displaying moving image data from the correction moving image data;
determining whether the displayed moving image is an optimum image or an image to be further improved; and
performing subtraction, multiplication and addition processing by use of a second slope coefficient different from the first slope coefficient, when the displayed moving image is determined to be the image to be further improved, and repeating the above processing until the moving image becomes the optimum image.

9. A method for driving a liquid crystal display device, comprising:
subjecting, when image data has a moving image region, a moving image portion to edge enhancement processing by use of a first edge enhancement coefficient;
storing the edge-enhanced moving image data in a frame memory;
subtracting previous frame moving image data stored in the frame memory from the edge-enhanced moving image data;
multiplying the moving image data subjected to the subtraction processing by use of a first slope coefficient;
adding the multiplied moving image data and the previous frame moving image data stored in the frame memory to obtain correction moving image data for overdrive;
displaying moving image data from the correction moving image data;
determining whether the displayed moving image is an optimum image or an image to be further improved;
performing subtraction, multiplication and addition processing by use of a second slope coefficient different from the first slope coefficient, when movement of the displayed moving image is determined to be not sharp, and repeating the above processing until the moving image becomes the optimum image; and
repeatedly performing edge enhancement processing on the basis of a second edge enhancement coefficient different from the first edge enhancement coefficient, when it is determined that there is glare on an image edge of the displayed moving image, until the moving image becomes the optimum image.

10. A method for driving a liquid crystal display device, comprising:
storing image data in a memory;
switching the image data outputted from the memory between a moving image and a still image;
when the image data is a moving image, subtracting previous frame moving image data stored in the memory from current frame moving image data; multiplying the moving image data subjected to the subtraction processing by use of a slope coefficient; adding the multiplied moving image data and the switched previous frame moving image data to obtain correction moving image data for overdrive; and
displaying images of the correction moving image data having an address designated and of still image data.

11. A liquid crystal display device comprising:
an edge enhancement circuit which enhances the edge of a moving image portion, the edge enhancement circuit having:
an edge detection circuit which receives an image signal, determines whether an image has a moving image region and a still image region, and, when there is the moving image region, calculates an edge enhancement coefficient according to a movement speed of a moving image;
a first subtracter which performs subtraction processing after receiving current frame image data and previous frame image data;
a first multiplier which performs multiplication processing on the basis of the edge enhancement coefficient outputted from the edge detection circuit after receiving a result of subtraction by the first subtracter; and
a first adder which performs addition processing after receiving a result of multiplication by the first multiplier and the previous frame image data;
a memory which receives edge enhancement image data outputted from the edge enhancement circuit after edge enhancement processing and stores the image data; and
a correction data generation circuit which performs overdrive processing when the image data is a moving image, the correction data generation circuit having:
a second subtracter which performs subtraction processing after receiving the edge enhancement image data and the previous frame image data outputted from the memory;
a second multiplier which performs multiplication processing by a predetermined multiplication factor after receiving a result of subtraction by the second subtracter; and
a second adder which performs addition processing after receiving a result of multiplication by the second multiplier and the previous frame image data outputted from the memory or the edge enhancement image data.

12. A liquid crystal display device including:
a memory which receives an image signal and stores image data;
a register which stores a slope coefficient inputted from outside;
a switching circuit which receives still image data outputted from the memory and previous frame moving image data, and selectively outputs any one of the received data; and
a correction data generation circuit which, when the image data is a moving image, performs overdrive processing and, when the image data is a still image, directly outputs the image data as still image data, the correction data generation circuit having:
a subtracter which subtracts the previous frame moving image data selected by the switching circuit from current frame moving image data;
a multiplier which receives a result of subtraction by the subtracter, and performs multiplication processing by use of the slope coefficient; and
an adder which receives a result of multiplication by the multiplier and the previous frame moving image data selected by the switching circuit, and performs addition processing.

13. The liquid crystal display device according to claim 12, wherein N (N is an integer not less than 2) pieces of the adders, of the multipliers and of the adders are provided, respectively.

14. A liquid crystal display device including:
a frame memory which receives an image signal and stores image data;
a register which stores a slope coefficient inputted from outside;
a first switching circuit which selectively outputs any one of M (M is an integer not less than 2) pieces of previous frame image data outputted from the frame memory;
a correction data generation circuit which, when the image data is a moving image, performs overdrive processing and, when the image data is a still image, directly outputs the image data as still image data, the correction data generation circuit having:
a subtracter which subtracts the previous frame image data selected by the first switching circuit from current frame image data;
a multiplier which receives a result of subtraction by the subtracter, and performs multiplication processing by use of the slope coefficient; and
an adder which receives a result of multiplication by the multiplier and the previous frame image data selected by the first switching circuit, and performs addition processing; and
a second switching circuit which selectively outputs the image data outputted from the correction data generation circuit to any one of m input terminals in an output circuit.

15. The liquid crystal display device according to claim 14, wherein N (N is an integer not less than 2) pieces of the adders, of the multipliers and of the adders are provided, respectively.
